(19) United States
(12) Patent Application Publication
(10) Pub. No.: US 2022/0212413 A1
(43) Pub. Date: Jul. 7, 2022

(54) METHOD OF CREATING A CERTIFIED DIGITAL PART FILE

(71) Applicant: Aurora Labs Limited, Canning Vale, Western Australia (AU)

(72) Inventors: David Budge, Canning Vale, Western Australia (AU); John Nathan Henry, Canning Vale, Western Australia (AU)

(73) Assignee: Aurora Labs Limited, Canning Vale, Western Australia (AU)

(21) Appl. No.: 17/601,987

(22) PCT Filed: Apr. 8, 2019
(86) PCT No.: PCT/AU2019/000045

§ 371 Date: Oct. 7, 2021

(51) Int. Cl. B29C 64/393; B33Y 50/02; G05B 19/4099

(52) U.S. Cl. CPC B29C 64/393; G05B 2219/49023; G05B 19/4099; B33Y 50/02

(57) ABSTRACT

A method is for printing a certified part using a certified digital part file. The method has the following steps: a. Using a 3D printing apparatus and a certified digital part file to print a part according to a print process, the certified digital part file having geometry, parameters and a check data set, the check data set having criteria defining acceptable and non-acceptable levels of anomalies for successful printing of the certified part, b. During the print process, comparing print data generated by the apparatus with the check data set to indicate where a part of the printing process contains a non-acceptable anomaly. c. Where a non-acceptable anomaly is detected, using the apparatus to recover the print process by taking corrective action if possible to remove the anomaly or reduce the anomaly to an acceptable level or, where the print process is not recoverable, abandoning the print process.

### FIELD OF THE INVENTION

The present invention relates to a method of creating a certified digital part file.

More particularly, the invention relates to a method of creating a certified digital part file capable of producing a certified part using a 3D printer.

### BACKGROUND

The rise and proliferation of 3D printers has had a marked disruptive effect on the manufacturing industry globally and is progressively leading to the decentralisation of manufacturing.

3D printers enable businesses and consumers to fabricate a wide range of objects rapidly and cost effectively. 3D printers are now capable of producing increasingly complex objects, including in respect to geometrical complexity and materials used. It is expected that consumers will soon be able to create spare parts for complex machines, and even functional consumer products, in their own home.

A problem is evident where a product is designed for a particular requirement, and said product is replicated in shape alone, with material properties not being replicated. Where the product is required to be fit for purpose, a product replicated by 3D printing is difficult to certify as fit for purpose.

One example of such a problem is where a replacement component for a large scale industrial machine is required. The component to be replaced may be of a particular geometry and material, but a 3D printed component in a similar material does not necessarily have the required material properties to be fit for purpose.

Parts produced by conventional subtractive manufacturing means, for example machining a forged or casted part, are typically mass produced and certification of parts is carried out by ensuring the quality across a product batch.

For example samples of the materials used may be tested, possibly by destructive testing, to ensure the material properties are to a sufficient standard.

The parts may be produced using a repeatable process, so that testing of some samples of the parts may be sufficient to certify the quality of the batch as a whole.

The certified mass produced parts may then be stored and shipped upon demand.

Facilities in remote locations may therefore store components that are known to be prone to failure, or that are known to cause significant down time due to failure, in an effort to reduce the risks of costly down time due to such failures.

The storage and associated inventory of these components raises problems which could be avoided if such storage were not required.

This ability to ‘print’ spare parts for complex machinery enables a remote location to print a required replacement component without having to wait for an order from a supplier to be delivered, resulting in saved time and therefore reduced costs due to down time.

The problem introduced by such a system is with regards to certification of the parts produced, which may appear substantially identical to the part to be replaced, but have no means to determine whether the part is fit for purpose, or certified.

It is known that various factors can influence a 3D printing process, and variations in environmental conditions or machine parameters for example, can have a detrimental effect on the part produced, to the extent that it may be unfit for purpose.

Anomalies may be present during the production process, for example porosity, thermal or chemical imbalances.

Whilst it may be possible for a 3D printer to ascertain that an anomaly has occurred in some cases, many anomalies go undetected and imperfections resulting from anomalies are typically detected in post-production testing, such anomalies can adversely affect the properties of a part, making it unsuitable for use.

This ability to ‘print’ spare parts for complex machinery also poses a threat to original equipment manufacturers (so-called OEMs) and presents a corresponding risk to consumers. OEMs typically license only particular accredited persons and businesses the right to manufacturer and/or sell certified spare parts for equipment that they produce. By purchasing certified parts, consumers are guaranteed a certain level of quality and workmanship.

3D printing has made it much easier for unaccredited persons to create and sell spare parts without a licence from the relevant OEMs. Consumers can also attempt to print their own spare parts for machinery that they own. For industrial and mechanical equipment, such as automobiles, using uncertified spare parts of substandard quality can have catastrophic and, in some cases, fatal consequences.

A challenge faced by both OEM's and printer manufacturers is the capability of 3D printing a part which is certified for use, without the requirement for testing post production. That is therefore retaining the benefits of being able to produce locally and on-demand, as opposed to requesting a part delivered from a remote location.

Known digital files are unable to produce certified parts, and 3D printed parts produced using digital files presently require post production testing to be declared fit for use, which is not conducive to the aim of producing replacement parts at short notice.

Even where post production testing is used to verify part quality, the testing is obviously limited to non-destructive testing as the part is required for use, such limitations make it impossible to verify some aspects of a 3D printed part.

The present invention attempts to overcome at least in part the aforementioned disadvantages of previous digital part files and methods of printing a certified part using a digital part file.

### SUMMARY OF THE INVENTION

In accordance with one aspect of the present invention, there is provided a method of creating a certified digital part file, the method comprising the following steps:
a. using a 3D printing apparatus and a digital part file to print an initial test part in accordance with a print process, the digital part file comprising initial geometry and initial parameters, wherein an initial print data set is generated during the print process, and wherein the initial print data set comprises print conditions that correspond to locations on the initial test part during the print process,
b. testing the initial test part to detect one or more anomalies and type and locations of each anomaly on the initial test part,
c. referencing each of the anomalies to the print conditions in the initial print data set corresponding to the location of each anomaly, to generate an anomaly data set, wherein the anomaly data set comprises the type and location of each of the anomalies and the relevant print conditions corresponding to each of the anomalies,
d. referring to the anomaly dataset and generating modified parameters to prevent similar anomalies reoccurring in subsequent prints,
e. if necessary, generating modified geometry to prevent the anomalies reoccurring in subsequent prints,
f. generating a check data set derived from the anomaly dataset during preceding steps a. through to e. of the method, wherein the check data set comprises criteria defining acceptable and non-acceptable levels of anomalies for successful printing of the finished part,
g. generating a revised digital part file comprising the initial geometry or, if applicable, modified geometry, the modified parameters and the check data set,
h. using the 3D printing apparatus and the revised digital part file to print a further test part in accordance with a print process, wherein a further print data set is generated during the print process, wherein the further print data set comprises further print conditions that correspond to locations on the further test part during the print process, and wherein the print process is carried out in accordance with the check data set, to ensure that any anomalies detected in the initial test part are not present in the further test part, or are only present within acceptable levels,
i. repeating steps b. through to h. using the further test part, further print data set and further print conditions, and any subsequent iterations of each, until a successful test part is printed in which no anomalies beyond an acceptable level are detected during testing at step b, wherein the final digital part file, used to print the successful test part, comprises the initial geometry or final modified geometry if applicable, final modified parameters and the check data set, and whereby the final digital part file constitutes the certified digital part file.

Preferably, the method of creating a certified digital part file further comprises the following steps after the successful test part has been produced at step i.
j. Printing multiple identical successful test parts, which are subsequently tested to confirm that no non-acceptable anomalies are present, and therefore verify the repeatability of the process, and where no non-acceptable anomalies are detected, the associated final digital part file constitutes the certified digital part file.
k. If anomalies at a level greater than acceptable are detected in one or more of the multiple identical parts, steps c. through to j. are repeated, until all multiple identical successful test parts are tested and no non-acceptable anomalies are detected, at which point the final digital part file, associated with the multiple identical successful test parts, constitutes the certified digital part file.

Preferably, the check data set comprises material and/or chemical properties of a finished part to be printed.

Preferably, the check data set further comprises go and no-go conditions, wherein the go and no-go conditions relate to, respectively, acceptable and non-acceptable criteria for successful printing of the finished part.

Preferably, the print conditions are measured by sensors of the 3D printing apparatus.

In accordance with another aspect of the present invention there is provided a certified digital part file for a 3D printing apparatus, the certified digital part file comprising geometry and certified parameters, wherein the certified parameters are derived from testing, wherein testing involves comparison of test parts printed using test parameters against corresponding test print data sets to determine a portion of the test parameters which has resulted in an anomaly detected in the test part, and modification of the test parameters to prevent similar anomalies being repeated.

Preferably certified parameters are derived from iterative testing of multiple test prints and corresponding test print data sets.

Preferably the print conditions are measured by sensors of the 3D printing apparatus.

Geometry may be modified in addition to parameters.

In accordance with another aspect of the present invention, there is provided a method of printing a certified part using a certified digital part file, the method comprising the following steps:
a. Using a 3D printing apparatus and a certified digital part file to print a part in accordance with a print process, the certified digital part file comprising geometry, parameters and a check data set, the check data set comprising criteria defining acceptable and non-acceptable levels of anomalies for successful printing of the certified part,
b. During the print process, comparing print data generated by the apparatus with the check data set to indicate where a part of the printing process contains a non-acceptable anomaly.
c. Where a non-acceptable anomaly is detected, using the apparatus to recover the print process by taking corrective action if possible to remove the anomaly or reduce the anomaly to an acceptable level or, where the print process is not recoverable, abandoning the print process.

Preferably, the criteria defining acceptable and non-acceptable levels of anomalies are derived from externals standards.

In accordance with another aspect of the present invention, there is provided a method of printing a certified part using a 3D printing apparatus and a knowledge base, wherein the knowledge base comprises anomaly patterns derived from a plurality of historical anomaly datasets, and a check data set comprising criteria defining acceptable limits for different types of anomalies, the method comprising the following steps:
a. Using a 3D printing apparatus to print a certified part, wherein the 3D printing apparatus is configured to recognise an anomaly pattern, and to therefore detect when an anomaly is being printed,
b. Checking the anomaly against the check data set to determine whether the anomaly is within acceptable limits, and where a non-acceptable anomaly is detected, recovering the print process by taking corrective action if possible to remove the anomaly or reduce the anomaly to an acceptable level or, where the print process is not recoverable, abandoning the print process.

Preferably, anomaly datasets are added to a master anomaly dataset, wherein the master anomaly data set comprises aggregated anomaly data collected from all other 3D printing apparatuses that have used the method to create certified digital part files.

More preferably, the master anomaly dataset becomes a knowledge base, to provide a means to identify anomalies at any location during any printing process.

Throughout the description, the following numbering convention shall be adhered to:
10—initial digital part file
11—further digital part file
15—certified digital part file
20—printing apparatus
30—initial test part
31—further test part
35—successful test part
40—initial geometry
41—modified geometry
45—final modified geometry
50—initial parameters
51—modified parameters
55—final modified parameters
60—initial print data set
61—further print data set
65—final print data
70—print conditions
71—further print conditions
80—anomalies
85—check data set
90—anomaly dataset
91—aggregated anomaly dataset
95—anomaly patterns
100—master data file
120—knowledge base

### BRIEF DESCRIPTION OF DRAWINGS

The present invention will now be described, by way of example, with reference to the accompanying drawings, in which:

FIG. 1 is a flow diagram depicting the method of creating a certified digital part file 15 according to an embodiment of the present invention.

FIG. 2 is a flow diagram depicting the method of creating a certified digital part file 15 according to an embodiment of the present invention, comprising additional steps to verify repeatability.

FIG. 3 is a flow diagram depicting the method of creating a certified part 38 using a certified digital part file 15 according to an embodiment of the present invention, comprising enhanced steps to provide a means of certifying a printing process.

FIG. 4 is a flow diagram depicting the method of creating a certified part 39 according to an embodiment of the present invention, comprising additional and enhanced steps to assist with anomaly detection during a printing process.

### DETAILED DESCRIPTION OF PREFERRED EMBODIMENTS

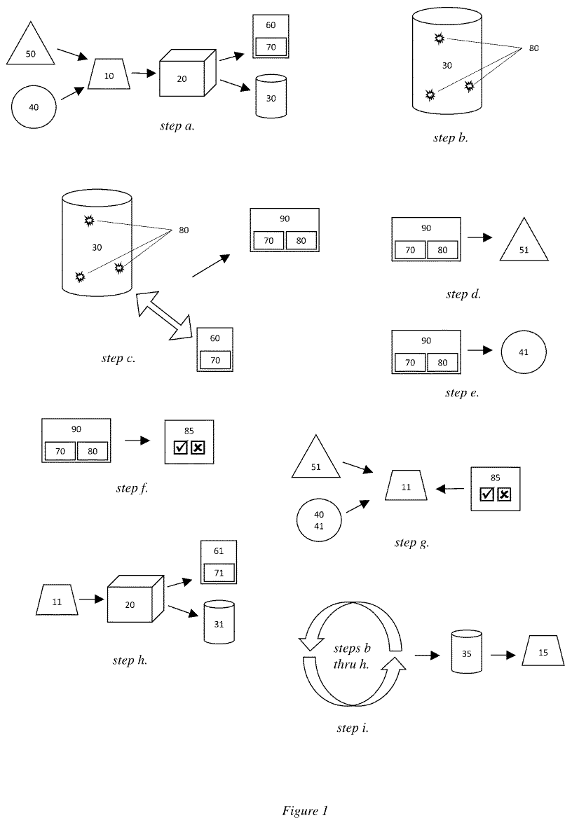

Referring to FIG. 1, there is shown a method of creating a certified digital part file 15, comprising the following steps;
a. using a 3D printing apparatus 20 and a digital part file 10 to print an initial test part 30 in accordance with a print process, the digital part file 10 comprising initial geometry 40 and initial parameters 50, wherein an initial print data set 60 is generated during the print process, and wherein the initial print data set 60 comprises print conditions 70 that correspond to locations on the initial test part 30 during the print process,
b. testing the initial test part 30 to detect one or more anomalies 80 and type and locations of each anomaly 80 on the initial test part 30,
c. referencing each of the anomalies 80 to the print conditions 70 in the initial print data set 60 corresponding to the location of each anomaly 80, to generate an anomaly data set 90, wherein the anomaly data set 90 comprises the type and location of each of the anomalies 80 and the relevant print conditions 70 corresponding to each of the anomalies 80,
d. referring to the anomaly dataset 90 and generating modified parameters 51 to prevent similar anomalies 80 reoccurring in subsequent prints,
e. if necessary, generating modified geometry 41 to prevent the anomalies 80 reoccurring in subsequent prints,
f. generating a check data set 85 derived from the anomaly dataset 90 during preceding steps a. through to e. of the method, wherein the check data set 85 comprises criteria defining acceptable and non-acceptable levels of anomalies 80 for successful printing of the finished part,
g. generating a revised digital part file 11 comprising the initial geometry 40 or, if applicable, modified geometry 41, the modified parameters 51 and the check data set 85,
h. using the 3D printing apparatus 20 and the revised digital part file 11 to print a further test part 31 in accordance with a print process, wherein a further print data set 61 is generated during the print process, wherein the further print data set 61 comprises further print conditions 71 that correspond to locations on the further test part 31 during the print process, and wherein the print process is carried out in accordance with the check data set 85, to ensure that any anomalies 80 detected in the initial test part 30 are not present in the further test part 31, or are only present within acceptable levels,
i. repeating steps b. through to h. using the further test part 31, further print data set 61 and further print conditions 71, and subsequent iterations of each, until a successful test part 35 is printed in which no anomalies 80 beyond an acceptable level are detected during testing at step b, wherein the final digital part file 15, used to print the successful test part 35, comprises the initial geometry 40 or final modified geometry 45 if applicable, final modified parameters 55 and the check data set 85, and whereby the final digital part file 15 constitutes the certified digital part file 15.

To create a certified digital part file 10, an initial test part 30 may be printed using the selected material (or materials) with the 3D printing apparatus 20.

The initial test part 30 is printed using initial geometry 40 and initial parameters 50 determined as being appropriate for the desired part 30.

The initial parameters 50 may include, but are not limited to, the travel speed of the energy beam, the power, intensity and focus of the energy beam, the rate of powder deposition and the preheating temperature of deposited powder, the powder bed and the baseplate of the 3D printing apparatus 20.

The initial parameters 50 may also include material and/or desired chemical properties of the finished part.

Further examples of initial parameters 50 may include, but are not limited to, backing gas, oxygen level, vacuum or pressure level, lasing strategy, chemistry, layer height's, cooling profile after a print, atmosphere for cooling and post print treatments.

The initial test part 30 may be printed using initial geometry 40 and initial parameters 50, but further in accordance with a check data set 85. The check data set 85 in this case may be limited to criteria relevant to anomalies of a type which are measureable without testing of the initial test part 30.

During the initial print process, the 3D printing apparatus 20 captures the initial print conditions 70, to create an initial print data set 60.

Print conditions 70 may be captured from the sensors or recording devices of the 3D printing apparatus 20.

The initial print data set 60 may include the measurements of features of the initial test part produced 30, and the conditions under which the initial test part 30 was printed. Measurements and conditions may include, for example, digital images of the initial test part 30 from multiple viewing positions, thermal, chemical and structural features of the initial test part 30, and physical states, changes and conditions relating to the printing process and resultant initial test part 30, such as oxygen levels, gas pressures and gas flows and dissipation of thermal energy.

The sensors and recording devices used to obtain the measurements and conditions may include high speed and resolution optical (and thermal) digital cameras and other sensors configured to obtain accurate readings during the printing process.

The initial print data set 60 may include data on every layer printed and the times at which the layers (and parts of the layers) were printed. Advantageously, this provides that a particular point in the print process can be identified, and data related to the initial print conditions 70 at the particular point in time and location can be retrieved.

The initial print data set 60 may include an image of each layer for example, which may assist with identifying voids or other imperfections on the initial test part 30 such as raised features or pockets.

The initial test part 30 produced as a result of the initial print process is then tested to ascertain whether it meets the requirements and is fit for purpose.

Tests which may be undertaken include destructive test and non-destructive tests, examples of tests may be x-ray, dye penetrant inspection and structural load testing, CT scanning, topological scanning, ultrasonic scanning and any other tests as required or deemed necessary

Tests may be performed by a third party and may be undertaken in compliance with appropriate standards.

The test results may identify any anomalies 80 within the initial test part 30. These anomalies 80 may include any feature or aspect of the initial test part 30 that is present or missing that causes the initial test part 30 to fail the applicable tests. For example the initial test part 30 may not exhibit a particular characteristic, feature or property that it is required to have, as identified during the tests.

The initial test part 30, and more particularly any anomalies 80 found, are then compared against the initial print data set 60, and the corresponding portion of the initial print data set 60 is used to determine the initial print conditions 70 which resulted in the anomaly 80.

For example, the anomaly 80 may be a void at a particular location on a particular layer. Review of the initial print data set 60 at the particular point on the particular layer provides the initial print conditions 70 which most likely resulted in the void being produced.

Each anomaly 80 that is identified and referenced to print conditions 70 at a particular portion of the initial print data set 60, the cross referenced information forms an anomaly dataset 90.

The anomaly data set 90, therefore, identifies the type, nature, magnitude and possible location of each of the anomalies 80 identified, and the relevant print conditions 70 that are considered to lead to the anomalies 80 occurring.

The complete anomaly data set 90 that is formed may then be added to a knowledge database 120. The knowledge database 120 comprises aggregated anomaly datasets 90 that may have been collected from any other 3D printing apparatuses that have also been used to create certified digital part files 15 using the method.

Using the anomaly dataset 90, modified parameters 51 may be defined to prevent the anomalies 80 (or similar anomalies) occurring during a subsequent print process.

Additionally parameters 51 may be modified at a specific location during the print to eliminate anomalies 80 typically identified in these locations.

For example where a void was detected at a particular position on a particular layer, the modified parameters 51 may deposit additional powder at the location to prevent a void.

Further examples of parameter modifications may include, but are not limited to, increasing or decreasing heat input, increasing or decreasing beam speed and modifying powder deposition to overcome failures identified during the testing process.

Furthermore, modified geometry 41 may be generated to prevent the anomalies 80 reoccurring in subsequent prints. In some circumstances, the modified geometry 41 that is generated may provide that a part subsequently printed in accordance with the modified geometry 41 does not have exactly the same morphology as the initial test part 30 but nevertheless has the characteristics, properties and functionality required by the part, or has improved characteristics, properties and functionality.

For example, if an initial test part 30 fails a particular test, such as a structural load test, despite there being no anomalies 80 present in the failure region, the modified geometry 41 may increase the cross-section at the failure location, to prevent similar failures.

Similar anomalies 80 and corresponding modifications may be attributable to different parameters 50, for example a thermal spike may cause one type of anomaly 80, whereas a chemical imbalance may be created by a different type of parameter 50.

Additional anomalies 80 may include positive or negative thermal spikes resulting in changed micro structure, porosity or chemical composition of the initial test part 30.

As used herein an anomaly 80 includes any variation in a material that is not consistent with a uniform or desired set of chemical, material and physical characteristics. The nature of the anomalies 80 may vary in magnitude.

Further criteria may exist in the form of external standards, which define what may be an acceptable level of anomaly 80 for any given use. For example components with extreme structural requirements, such are aerospace components, may include a particularly narrow set of criteria when defining acceptable levels of porosity for example.

Alternatively, a replacement component for a tractor may have a much greater acceptable level of porosity.

The initial print data set 60 may be cleansed to remove unnecessary data so that only issues for the purpose of the comparison are shown. For example, this may be done by comparing the initial print data set 60 with another print data set generated when a perfectly printed object or material is created. This comparison allows non-anomaly based data to be removed from the initial print data set 60 so that only anomaly-related data (and corresponding location data) remains. Other methods may involve using machine learning or similar AI techniques to analyse the initial print data set 60 which may include, for example, comparing the initial print data set 60 with the knowledge base 120.

It may be that an anomaly 80 is detected by one type of test which would not be detected by a different type of test.

It may therefore be required that multiple tests may be required to detect all anomalies 80, and to therefore determine which initial print conditions 70 resulted in each anomaly 80.

Anomalies 80 also vary in magnitude and frequency, and where anomalies 80 are sufficiently small or infrequent, the functionality of the part may be unaffected.

After the modified parameters 51 and (if any) modified geometry 41 have been created, a check data set 85 may then be generated which is derived from the anomaly dataset 90.

The check data set 85 may comprise a set of go and no-go conditions. The go and no-go conditions relate to, respectively, acceptable and non-acceptable criteria for successful printing of the finished part. The criteria comprise, respectively, acceptable and non-acceptable levels of anomalies 80 for successful printing of the finished part.

The check data set 85 may further be defined by external standards requirements.

Alternatively, an initial check data set 85 may be used when printing the initial test part 30, where the criteria are derived from external standards.

In this case, the criteria of the check data set 85 may be limited to criteria relevant to anomalies of a type which are measureable without testing of the initial test part 30.

The check data set 85 may then be aggregated with further anomaly 80 data contained in subsequent anomaly data sets 90.

A revised digital part file 11 is then generated which comprises the initial geometry 40 or (if applicable) modified geometry 41, the modified parameters 51 and the check data set 85. The revised digital part file 11 may comprise other data, as necessary, relating to the anomalies 80 and that determine the subsequent operation of the 3D printing apparatus 20 to avoid reoccurrence (or acceptance of reoccurrence) of the anomalies 80.

A second test part 31 is then printed using the revised digital part file 11. When the second test part 31 is being printed, a further print data set 61 is generated using the sensors or recording devices of the apparatus 20, the further print data set 61 comprising the further print conditions 71. This further print data set 61 is compared with the check data set 85 during the print process. This comparison is carried out to ensure that the conditions that caused the anomalies 80 to previously occur are avoided, or the anomalies 80 are avoided within certain defined tolerances, error margins or acceptance limits.

The check data set 85 may be used to take corrective action when the second test part 31 is being printed, and to verify that the process has been undertaken within the acceptable limits, which can therefore be understood to not contain anomalies 80 of a magnitude and/or frequency which would cause the part to fail.

The steps described above are then repeated iteratively until a successful test part 35 is printed in which no anomalies above an acceptable level 80 are detected.

Where the second test part 31 is found to contain anomalies 80 during the testing process, the anomaly 80 data is referenced to further print conditions 71 at a particular portion of the further print data set 61, the cross referenced information is added to the anomaly dataset 90, thus forming an aggregated anomaly dataset 91.

The revised digital part file 11 that exists on completion of the method, therefore, comprises the final revised versions of the initial geometry 40 and/or (as applicable) modified geometry 45, the modified parameters 55, print conditions 75 and the check data set 85. The revised digital part file 11 may include further data, as necessary, relating to fabrication of the finished part.

It will be understood that the final revised digital part file 11 constitutes the certified digital part file 15. The inclusion of the check data set 85 in the certified digital part file 15 further allows corrective and preventative action to be taken during the printing process, resulting in reduced scrap and increased conformance.

The check data set 85 may also allow a 3D printing apparatus 20 to determine whether, upon identifying an anomaly 80, the printing process may be adjusted to rectify the anomaly 80, or whether the part is not recoverable, at which point the process can be halted. Each layer may achieve a pass or fail result following comparison with the check data set 85. Halting or recovering the printing process prevents wasted time and costs, by preventing an unrecoverable print from finishing its process.

Examples of anomalies 80 which may be recovered include a layer of insufficient thickness, where the parameters 51 of the subsequent layer may be modified to provide additional thickness over the desired area, or porosity within a layer, which may be filled or re-melted by redirecting the energy beam.

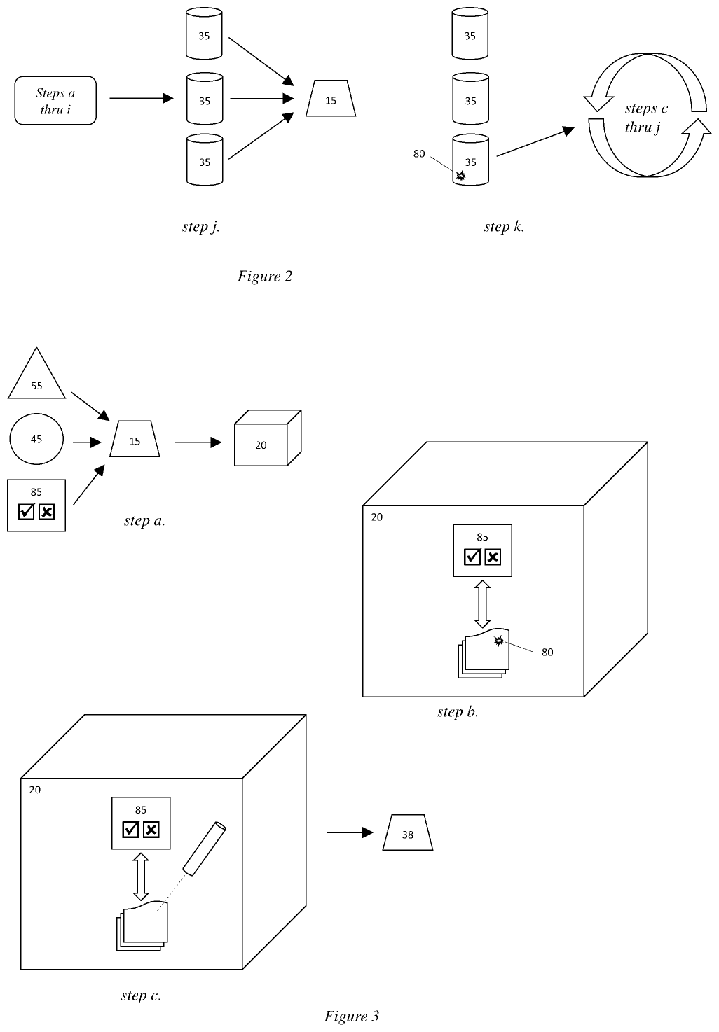

Referring to FIG. 2, there is shown a method of creating a certified digital part file 15, comprising the steps described in FIG. 1, and further comprising the following steps after the successful test part 35 has been produced at step i.
j. Printing multiple identical successful test parts 35, which are subsequently tested to confirm that no non-acceptable anomalies are present, and therefore verify the repeatability of the process, and where no non-acceptable anomalies are detected, the associated final digital part file 15 constitutes the certified digital part file 15.
k. If anomalies 80 at a level greater than acceptable are detected in one or more of the multiple identical parts 35, steps c. through to j. are repeated, until all multiple identical successful test parts 35 are tested and no non-acceptable anomalies are detected, at which point the final digital part file 15, associated with the multiple identical successful test parts 35, constitutes the certified digital part file 15.

Parts with more stringent certification needs may require that a number of identical tests are undertaken to ensure repeatability of the process. In such cases the geometry 45 and parameters 55 associated with the successful test part 35 may be used to print a number of identical successful test parts 35.

The number of successful test parts 35 required may be determined by the requirements of the part or operator, for example critical parts may require a high number of successful test parts 35 to be tested to certify, whereas less critical parts may not require additional parts to be printed at all.

The identical successful test parts 35 may then undergo testing to ascertain whether all the successful test parts 35 are fit for purpose.

Where one or more successful test parts 35 fail the testing, investigation may be required to check for anomalies 80 which may have caused the failure.

Further parameter 55 modifications may be made, and subsequent additional test parts 35 printed.

A digital part file 15 is considered to have been certified once a required number of identical successful test parts 35 have been printed using particular parameters 55 and geometry 45, and all the identical successful test parts 35 have completed the testing process without non-acceptable anomalies 80 being detected.

The particular parameters 55 and geometry 45 used to create the successful test part 35 are used to create the certified digital part file 15.

Once a certified digital part file 15 has been created, a master data file 100 is stored, which may include the history of all previous prints and associated parameters 50, print data sets 60 and test results, so that the entire verification process is available.

The comparison of test results against the print data set 60, and the use of this information to identify parameters 51 which lead to anomalies 80, allows anomalies 80 to be consistently kept within acceptable limits, thus enables a part which has been printed using a certified digital part file 15 to be considered certified, potentially without the need for further testing.

It is recognised that some requirements for post-production processing or testing may remain, depending on the requirements. Therefore the method described does not entirely remove the need to any post production processing in all cases.

Examples of post-production testing which may still be required include heat treatment, stress relief, surface treatments and third party testing.

A part produced using a certified digital part file 15 may therefore be understood to be a certified part 35.

In use, OEMs or part owners may store certified digital part files 15 of critical components, for example those which lead to substantial costs due to failure.

The availability of certified digital part files 15 overcomes the problem of 3D printed parts not being fit for purpose without post-productions testing, and therefore allows rapid replacement of a failed part.

The availability of certified digital part files 15 also overcomes the problem of storing parts for replacement in the event of a failure, and the associated inventory issues with such storage.

Where a certified part 38 is required, for example following the failure of a component, the certified digital part file 15 is requested by an end user, using a 3D printing machine.

The end user will typically have a requirement for a certified part 35 capable of performing under certain conditions.

If the end user were to download an object file from an uncertified source, or to scan an existing part in an effort to reproduce the part, the end user would have no way of knowing whether the part would perform under the required conditions. The end user would be required to undertake post-production testing, or may have no option other than the order the certified replacement part from the OEM.

Where the end user requests the certified digital part file 15, the aforementioned process ensures that the geometry 45 and parameters 55 used to print the part, will result in a certified part 35 capable of performing under the required conditions. The process has been proven by the multiple tests from which the parameters 55, and possibly geometry 45 have been derived.

As the process may have been used to create and verify a number of parts, the certified digital part file 15 has been proven to be able to produce certified parts 35, which may be sufficient in some cases. However, if the certified digital part file 15 is supplied to the 3D printing apparatus 20, and the printing process is carried out without further monitoring, external factors may result in further anomalies 80.

Known 3D printing apparatus do not have a means of recognising some anomalies 80, and therefore do not have a means of certifying the production process without a degree of post-production testing, even when supplied with a certified digital part file 15.

Furthermore, adequate post-production testing may not be available, or even possible without destruction of the part.

For example, a 3D printing apparatus 20 may be knocked during the printing process, or the different geographical location, relative to the 3D printing apparatus 20 on which the certification process was undertaken, may be subject to different environmental conditions, which may in turn result in new anomalies 80 occurring.

Where the prevalence and magnitude of these new anomalies 80 are considered to be significant, the certification of the part may be at risk, even though the certified digital part file 15 was used.

To ensure that the part produced by a printer using the certified digital part file 15 is itself a certified part 38, the printing process used to print the part may also need be certified.

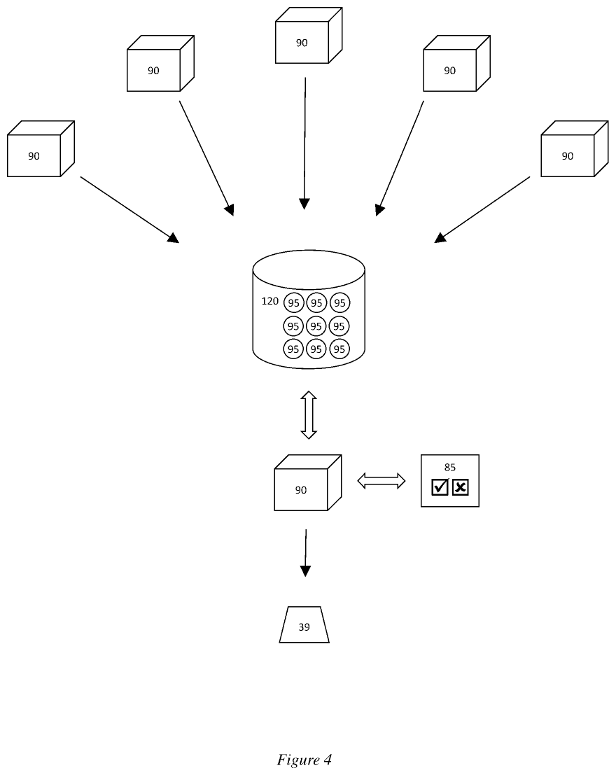

Referring now to FIG. 3, there is provided a method of printing a certified part 38 using a certified digital part file 15, the method comprising the following steps:
a. Using a 3D printing apparatus 20 and a certified digital part file 15 to print a part 38 in accordance with a print process, the certified digital part file 15 comprising geometry 45, parameters 55 and a check data set 85, the check data set 85 comprising criteria defining acceptable and non-acceptable levels of anomalies 80 for successful printing of the certified part 38,
b. During the print process, comparing print data 65 generated by the apparatus 20 with the check data set 85 to indicate where a part of the printing process contains a non-acceptable anomaly 80.
c. Where a non-acceptable anomaly 80 is detected, using the apparatus 20 to recover the print process by taking corrective action if possible to remove the anomaly 80 or reduce the anomaly 80 to an acceptable level or, where the print process is not recoverable, abandoning the print process.

Where the method of FIG. 3 allows a print process to be certified, and therefore produce a certified part 38 using a certified digital part file 15 and a certified printing process, this is done in part using the check data set 85, which comprises the test results of the iterative testing used to derive the certified digital part file 15.

Whilst this check data set 85 is able to be used to provide a means to recognise anomalies 80 in a particular location of a particular part, as the information is based on the iterative testing of a number of similar parts, the information may be, to some extent at least, limited to such parts.

Referring now to FIG. 4, there is shown a method of printing a certified part 39 using a 3D printing apparatus and a knowledge base 120, wherein the knowledge base 120 comprises anomaly patterns 95 derived from a plurality of historical anomaly datasets 90, and a check data 85 set comprising criteria defining acceptable limits for different types of anomalies 80, the method comprising the following steps:
d. Using a 3D printing apparatus 20 to print a certified part 39, wherein the 3D printing apparatus is configured to recognise an anomaly pattern 95, and to therefore detect when an anomaly 80 is being printed,
e. Checking the anomaly 80 against the check data set 85 to determine whether the anomaly is within acceptable limits, and where a non-acceptable anomaly 80 is detected, recovering the print process by taking corrective action if possible to remove the anomaly 80 or reduce the anomaly 80 to an acceptable level or, where the print process is not recoverable, abandoning the print process.

The anomaly patterns 95 stored in a knowledge base 120 are able to provide a means to identify anomalies 80 at any location during any printing process.

Whilst the comparison of the test results against the print data set 60 at a particular location of the test part 30 may be used to determine the parameters 50 used at said location, and therefore to assist with creation of modified parameters 51, this is specific to the particular location of the particular part, and is recorded against the part file associated with the particular part.

As more tests are undertaken, and results comparing more anomalies 80 with more corresponding print data sets 60, a knowledge base 120 may be created, and anomaly patterns 95 can be identified and stored in the knowledge base 120.

As more anomaly patterns 95 are identified, the size of the knowledge base 120 increases.

The analysis of the patterns can be used to identify the parameters 50 which may result in an anomaly 80, regardless of the location within the part. For example it may be discovered that a particular rate of powder deposition may result in more voids than previously anticipated.

It may further be recognised that a combination of particular parameters 50 may result in an anomaly 80, but not when only one of the parameters 50 is used. For example a particular beam intensity may cause excessive melting at a particular speed of traverse.

Where anomalies 80 are identified that are produced repeatedly, regardless of the location within the part, their respective anomaly datasets 90 can be used to define anomaly patterns 95.

The anomaly patterns 95 can be used to identify when a 3D printing apparatus 20 is producing an anomaly 80, which can therefore be used to carry out corrective or preventative actions during a print process, thereby increasing the efficiency of the 3D printing apparatus 20.

The check data set 85 may be altered for different parts and part requirements, what constitutes an acceptable level of anomaly 80 may vary depending on the requirements of the part, and as such, a check data set 85 may be selected which is appropriate for the part to be printed.

Modifications and variations as would be apparent to a skilled addressee are deemed to be within the scope of the present invention.

1.-10. (canceled)

11. A method of creating a certified digital part file, the method comprising the following steps:
a. using a 3D printing apparatus and a digital part file to print an initial test part in accordance with a print process, the digital part file comprising initial geometry and initial parameters, wherein an initial print data set is generated during the print process, and wherein the initial print data set comprises print conditions that correspond to locations on the initial test part during the print process,
b. testing the initial test part to detect one or more anomalies and type and locations of each anomaly on the initial test part,
c. referencing each of the anomalies to the print conditions in the initial print data set corresponding to the location of each anomaly, to generate an anomaly data set, wherein the anomaly data set comprises the type and location of each of the anomalies and the relevant print conditions corresponding to each of the anomalies,
d. referring to the anomaly dataset and generating modified parameters to prevent similar anomalies reoccurring in subsequent prints,
e. if necessary, generating modified geometry to prevent the anomalies reoccurring in subsequent prints,
f. generating a check data set derived from the anomaly dataset during preceding steps a. through to e. of the method, wherein the check data set comprises criteria defining acceptable and non-acceptable levels of anomalies for successful printing of the finished part,
g. generating a revised digital part file comprising the initial geometry or, if applicable, modified geometry, the modified parameters and the check data set,
h. using the 3D printing apparatus and the revised digital part file to print a further test part in accordance with a print process, wherein a further print data set is generated during the print process, wherein the further print data set comprises further print conditions that correspond to locations on the further test part during the print process, and wherein the print process is carried out in accordance with the check data set, to ensure that any anomalies detected in the initial test part are not present in the further test part, or are only present within acceptable levels,
i. repeating steps b. through to h. using the further test part, further print data set and further print conditions, and any subsequent iterations of each, until a successful test part is printed in which no anomalies beyond an acceptable level are detected during testing at step b, wherein the final digital part file, used to print the successful test part, comprises the initial geometry or final modified geometry if applicable, final modified parameters and the check data set, and whereby the final digital part file constitutes the certified digital part file.

12. The method of creating a certified digital part file according to claim 11, the method further comprising the following steps after the successful test part has been produced at step i:
j. printing multiple identical successful test parts, which are subsequently tested to confirm that no non-acceptable anomalies are present, and therefore verify the repeatability of the process, and where no non-acceptable anomalies are detected, the associated final digital part file constitutes the certified digital part file.
k. if anomalies at a level greater than acceptable are detected in one or more of the multiple identical parts, steps c. through to j. are repeated, until all multiple identical successful test parts are tested and no non-acceptable anomalies are detected, at which point the final digital part file, associated with the multiple identical successful test parts, constitutes the certified digital part file.

13. The method of creating a certified digital part file according to claim 11, wherein the check data set comprises material and/or chemical properties of a finished part to be printed.

14. The method of creating a certified digital part file according to claim 11, wherein the check data set further comprises go and no-go conditions, wherein the go and no-go conditions relate to, respectively, acceptable and non-acceptable criteria for successful printing of the finished part.

15. The method of creating a certified digital part file according to claim 11, wherein the print conditions are measured by sensors of the 3D printing apparatus.

16. A certified digital part file for a 3D printing apparatus, the certified digital part file comprising geometry and certified parameters, wherein the certified parameters are derived from testing, wherein testing involves comparison of test parts printed using test parameters against corresponding test print data sets to determine a portion of the test parameters which has resulted in an anomaly detected in the test part, and modification of the parameters to prevent similar anomalies being repeated.

17. The certified digital part file for a 3D printing apparatus according to claim 16, wherein certified parameters are derived from iterative testing of multiple test prints and corresponding test print data sets.

18. A method of printing a certified part using a certified digital part file, the method comprising the following steps:
a. using a 3D printing apparatus and a certified digital part file to print a part in accordance with a print process, the certified digital part file comprising geometry, parameters and a check data set, the check data set comprising criteria defining acceptable and non-acceptable levels of anomalies for successful printing of the certified part,
b. during the print process, comparing print data generated by the apparatus with the check data set to indicate where a part of the printing process contains a non-acceptable anomaly.
c. where a non-acceptable anomaly is detected, using the apparatus to recover the print process by taking corrective action if possible to remove the anomaly or reduce the anomaly to an acceptable level or, where the print process is not recoverable, abandoning the print process.

19. The method of printing a certified part using a certified digital part file according to claim 18, wherein the criteria defining acceptable and non-acceptable levels of anomalies are derived from externals standards.

20. A method of printing a certified part using a 3D printing apparatus and a knowledge base, wherein the knowledge base comprises anomaly patterns derived from a plurality of historical anomaly datasets, and a check data set comprising criteria defining acceptable limits for different types of anomalies, the method comprising the following steps:
a. using a 3D printing apparatus to print a certified part, wherein the 3D printing apparatus is configured to recognize an anomaly pattern, and to therefore detect when an anomaly is being printed,
b. checking the anomaly against the check data set to determine whether the anomaly is within acceptable limits, and where a non-acceptable anomaly is detected, recovering the print process by taking corrective action if possible to remove the anomaly or reduce the anomaly to an acceptable level or, where the print process is not recoverable, abandoning the print process.

21. The method of creating a certified digital part file according to claim 12, wherein the check data set comprises material and/or chemical properties of a finished part to be printed.

22. The method of creating a certified digital part file according to claim 12, wherein the check data set further comprises go and no-go conditions, wherein the go and no-go conditions relate to, respectively, acceptable and non-acceptable criteria for successful printing of the finished part.

23. The method of creating a certified digital part file according to claim 13, wherein the check data set further comprises go and no-go conditions, wherein the go and no-go conditions relate to, respectively, acceptable and non-acceptable criteria for successful printing of the finished part.

24. The method of creating a certified digital part file according to claim 12, wherein the print conditions are measured by sensors of the 3D printing apparatus.

25. The method of creating a certified digital part file according to claim 13, wherein the print conditions are measured by sensors of the 3D printing apparatus.

26. The method of creating a certified digital part file according to claim 14, wherein the print conditions are measured by sensors of the 3D printing apparatus.
